(19) United States
(12) Patent Application Publication
(10) Pub. No.: US 2006/0016450 A1
(43) Pub. Date: Jan. 26, 2006

(54) AIR FILTER DEVICE FOR THE NOSE

(76) Inventors: Alfred E. Pearson, Castle Rock, CO (US); Jeffrey T. Samson, Boulder, CO (US)

Correspondence Address: MARTIN & HENSON, P.C., 9250 W 5TH AVENUE, SUITE 200, LAKEWOOD, CO, 80226, US

(21) Appl. No.: 11/160,584

(22) Filed: Jun. 29, 2005

Related U.S. Application Data
(63) Continuation-in-part of application No. 29/208,612, filed on Jun. 29, 2004.
(63) Continuation-in-part of application No. 29/208,551, filed on Jun. 29, 2004.

(51) Int. Cl. A61G 10/00

(52) U.S. Cl. 128/206.11; 128/205.27; 128/205.29

(57) ABSTRACT

A filter device mounts on a person's nose and fits within the nostrils to filter breathed air. The device includes a support member having a pair of annular sections and a pair of side sections that extend upwardly from outer edges thereof. A filter piece is disposed in each annular section so that the filter pieces seat in respective nostrils. A portion of the support member is malleable so that the support member may be configured to the shape of the wearer's nose. In one embodiment the side sections are interconnected by a bridge section that goes across the bridge of the nose. In another embodiment, the annular sections are interconnected by a band extending between inner edges thereof. The filter pieces may be convex domes that, as disclosed, have a flat margin and a frusto-conical section to form a seat for the nostrils.

### BACKGROUND OF THE INVENTION

The disclosed embodiments herein relate to air filtration devices that may be worn on a person's nose in order to enhance the cleanliness of air inhaled through the nostrils. One aspect, then, of these embodiments, is to provide a simple and inexpensive product which acts as an interface between the ambient air and a person's respiratory system in order to remove particulate matter during breathing. Another aspect of these embodiments is to provide the personal air filtration device which can conform to differently shaped noses yet which is comfortable to wear. A further aspect of at least some of these embodiments is to provide a disposable filtration device which may be worn for a desired period of time and then discarded.

It is well known that, for a variety of health or comfort reasons, many people wish to clean the air that is passing into their lungs through the nasal passageways. Such desire may rise from specific health considerations or from a general desire to avoid particulate matter, such as dust and smoke entrained in the air. In addition, it may be desirable to remove certain odors from the air.

In the past, it has been known to provide various filtration devices which may be positioned over a person's nose and/or mouth in order to remove particulate contaminants from the inhaled air. Typically, a mask was provided that included a cup-shaped piece of filter material to which elastic bands, string or loops are provided to secure the mask to the head of the wearer by extending over the ears or around the back of the neck. Attentatively, it is known to use adhesives to hold the filter material in place. In many instances, persons have felt that such masks were uncomfortable to wear. In addition, many persons have felt that such masks detract from their appearance so that they were reluctant to these masks in public.

In addition, the use of masks which cover the nose and/or mouth of the wearer may allow unfiltered air to get around parts of the mask which are not seeded sufficiently against the curves of the face. When these masks get wet by rain or water, they may become additionally uncomfortable to wear and, in some instances, difficult to breath through. Such masks may also cause excessive sweating, especially in hot climates, and, may cause eyeglasses to fog due to water vapor exiting the top of the mask, especially during cooler weather. Because the mask is closely attached to the face, the skin may become irritated, and, where the mask is hung on the ears, the skin of the ears may become chaffed. Finally, the ability of the person wearing the mask to communicate when talking is diminished.

As a result, it has also been known to provide various inserts for a person's nostrils in order to dispense with the mask device discussed above. Nostril inserts, however, may be uncomfortable where they are forced to fit into the nostrils in order to be held in place. Indeed, many people find nostril inserts to be very distracting, and these nostril inserts may result in an undesirable nasal twang when the person speaks. Such devices, for example, are shown in U.S. Pat. No. 5,417,205 issued May 23, 1995 to Wang, and U.S. Pat. No. 6,119,690 issued Sep. 19, 2000 to Pantaleo and U.S. Pat. No. 3,905,335 issued Sep. 16, 1975 to Kapp.

In addition to these nasal inserts, it has also been known to provide an air filter device which only partially inserts into the wearer's nostrils. An example of such device is shown in U.S. Pat. No. 5,485,386 issued Jan. 23, 1996 to Lincoln. Here, the filter structure is positioned under the nose with portions of the structure extending into the nostrils. The structure is mounted to the nose by means of adhesive strips which extend upwardly along side the nose and are adhered to the person's skin in order to hold the structure in place.

While the prior art devices are directed to providing enhanced air quality for the inhaled air, there nonetheless remains a need for improved devices which are more comfortable for the wearer. There is a further need for such devices to be inexpensive in cost so that they may be used and subsequently disposed. The disclosed embodiments described herein are directed to meeting such needs.

### SUMMARY OF THE EXEMPLARY EMBODIMENTS

Accordingly, the filter assemblies according to the exemplary embodiments of the present invention are adapted to mount on a person's nose and fit within the person's nostrils when in a mounted state. Broadly, the disclosed embodiments include a support member that has a pair of annular sections and a pair of side sections extending upwardly from outer locations of the annular sections. At least some portion of the support member is malleable so that the support member may be configured to conform to the shape of the person's nose when in the mounted state thereby to secure the support member to the person's nose. When so secured, the annular portions are spaced apart from one another a distance corresponding to the distance between the person's nostrils. A pair of filter pieces are provided with there being a filter piece disposed in each of the annular sections. These filter pieces are then supported by the support member for seated engagement with respective ones of the person's nostrils.

In at least some of the exemplary embodiments, the side sections are formed of a malleable material so that the side portions can be configured to extend alongside the sides of the person's nose in generally confronting relation thereto. In several embodiments, the side sections are interconnected by a bridge section configured to extend across the bridge of the person's nose, with the bridge section being formed of a malleable material. In some embodiments, the annular sections are interconnected by a band section extending between inner locations of the annular sections that are generally opposite the outer locations thereof. This band section may have an arch-shaped configuration adapted to receive the columella of the person's nose.

The filter pieces, in some embodiments, may be interconnected by an inner strip of filter material. In some instances, an outer strip of filter material may extend outwardly of each of the filter pieces. Each of the filter pieces may, if desired, be formed as a shell having a generally convex shape. Here, each filter piece may have an outer rim, a generally flat margin section adjacent the rim and a frustoconical section extended upwardly from an inner edge portion of the margin. Thus, the margin section of the frustoconical section form a seat for the edges of the person's nostrils. If desired, each filter piece can have a generally flat landing section extending from an upper edge portion of the frustoconical section and a dome-shaped section extending upwardly from an inner portion of the landing section. The filter material may be any suitable fiber material and, if desired, can be comprised of electrostatically charged fibers or include activated charcoal.

The malleable material may be selected from a group consisting of plastics, metals and plastic coated metals. In certain embodiments, the support member includes a substrate formed of a plastic material and a metallic rib secured to the substrate as the malleable material.

### BRIEF DESCRIPTION OF THE DRAWINGS

FIG. 1 is a perspective view of a first exemplary embodiment of the present invention shown in a mounted state on a person's nose;

FIG. 2 is a perspective view of the first exemplary embodiment of the present invention;

FIG. 3 is a side view in elevation of the filter assembly according to the first embodiment of the present invention;

FIG. 4 is a rear view in elevation of the filter assembly of FIGS. 2 and 3;

FIG. 5 is a cross-sectional view taken about lines 5-5 of FIG. 4;

FIG. 6 is a cross-sectional view of a portion of the filter assembly of FIGS. 2-5 shown ceded in a person's nostril;

FIG. 7 is a perspective view of a second exemplary embodiment of the present invention;

FIG. 8 is a side view in cross-section taken about lines 8-8 of FIG. 7;

FIG. 9 is a perspective view of a third exemplary embodiment of the present invention shown in a mounted state on a person's nose;

FIG. 10 is a perspective view of the third exemplary embodiment of the present invention;

FIG. 11 is a perspective view of a fourth exemplary embodiment of the present invention; and

FIG. 12 is an exploded front view in cross-section showing the construction of the filter assembly of FIG. 11.

### DETAILED DESCRIPTION OF THE EXEMPLARY EMBODIMENTS

The exemplary embodiments of the present invention relate to filter devices that are adapted to mount on a person's nose and which have filter pieces that fit within a person's nostrils when in a mounted state in order to assist in filtering air that is breathed by a person. Broadly these embodiments include a support member having a pair of annular sections that receive filter pieces for seated engagement with the person's nostrils. The support member has side sections that extend upwardly so as to help secure the device to the nose with at least some portion of the support member being malleable so that the support member may be configured to the shape of the person's nose. By “malleable” it is intended that the shape of the support member may be at least slightly changed by being bent yet which will hold the shape under normal circumstances after being so configured.

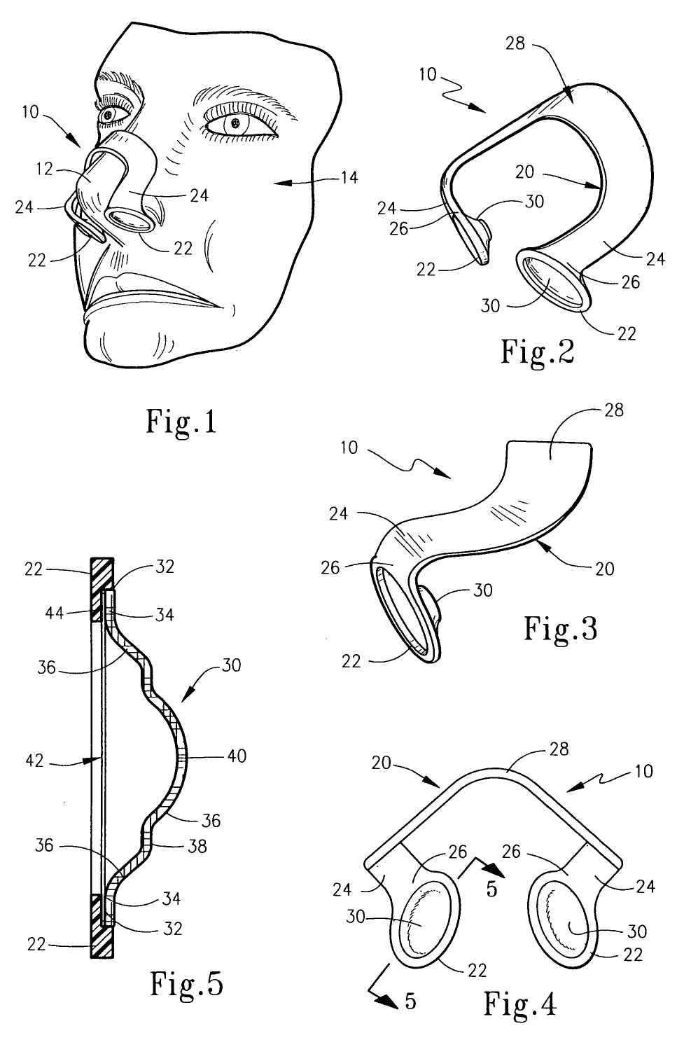

With reference to FIG. 1, then, a first exemplary embodiment of filter assembly 10 is shown in a mounted state on the nose 12 of a person's face 14. Filter device 10 is illustrated in greater detail in FIGS. 2-4 where it may be seen that filter device 10 includes a support member 20 that includes a pair of annular sections 22 and a pair of side sections 24 which extend upwardly from outer locations 26 of annular sections 22. It should be understood that, in the context of this disclosure, the word “annular” should not be confined to being circular, such that annular sections 22 could have an oval, elliptical or other closed loop geometric shape. With reference again to FIG. 1, it may be seen that side sections 24 extend along the sides of the person's nose with annular portions 22 being spaced apart from one another a distance corresponding to the distance between a person's nostrils.

With reference now to FIGS. 2-4, it may be seen that filter device 10 includes a pair of filter pieces 30 are provided with there being one filter piece 30 disposed in each of annular sections 22 so that they are supported by the support member for seated engagement with respective ones of the person's nostrils (again as seen in FIG. 1). As noted above, annular sections 22 receive filter pieces 20, and In order to configure the support member for conformity to the shape of the wearer's nose, at least some portion of the support member should be formed of a malleable material. This malleable material may be any suitable plastic, metal or combination of plastic and metal which lends sufficient rigidity to the support member so that it will hold its shape during use yet which will allow selective configuration in forming of the support member to the contour of the nose.

In the embodiment shown in FIGS. 2-4, support member 20 includes a bridge section 28 which is configured to extend across the bridge of the person's nose when in the mounted state. As is seen, bridge section 28 interconnects side sections 24 to form a continuous band between the outer locations 26 of each annular section 22 with this band extending across the bridge of the person's nose. In this embodiment, side sections 24 and bridge section 28 are all formed by the malleable material.

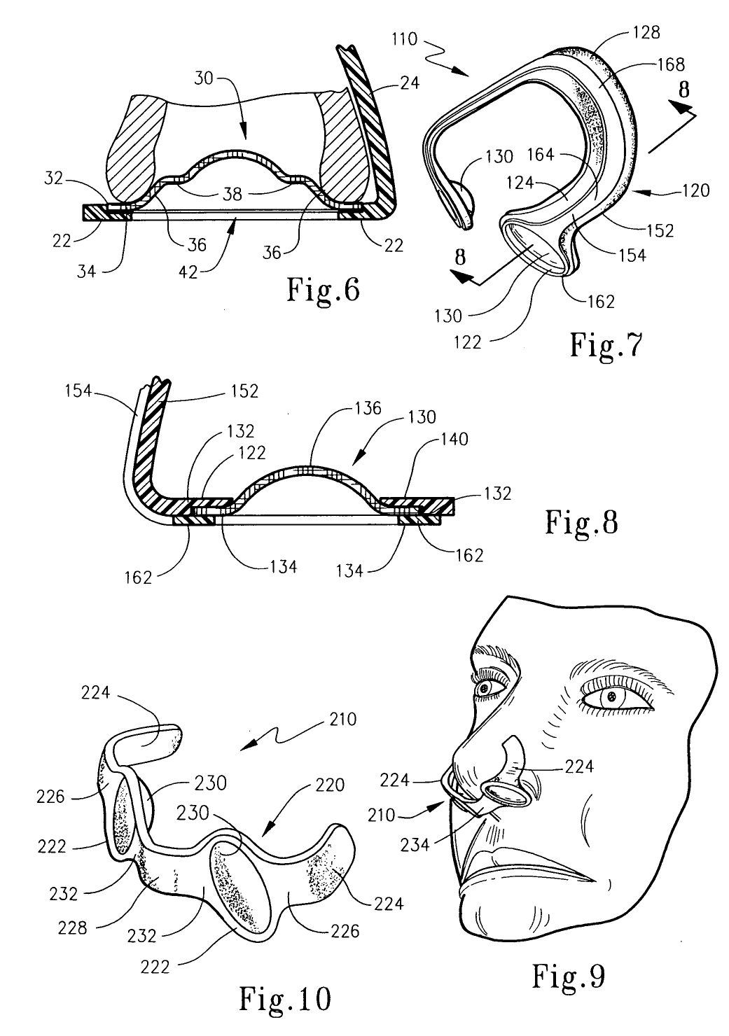

The structure of filter piece 30 according to the first exemplary embodiment of the present invention is illustrated in FIGS. 5 and 6. Here, it may be seen that a representative filter piece 30 is formed as a shell having a generally convex shape. With greater detail, though, filter piece 30 has an outer rim 32 with a generally flat, annular margin section 34 adjacent the rim. A frustoconical section 36 extends upwardly from an inner edge portion of the margin with the margin section 34 and the frustoconical section 36 forming a seat for the edges of the person's nostrils, as is best illustrated in FIG. 6.

With further detail, each filter piece 30 has a generally flat, annular landing section 38 extending from an upper edge portion of the frustoconical section and a dome-shaped section 40 extending upwardly from an inner edge portion of the landing section 38. Each of filter pieces 30 may be secured across the opening 42 of annular section 22 and secured to annular section 22, for example, by means of an adhesive 44. Naturally, other methods of attaching filter piece 30 in annular section 22 are contemplated by this invention as would be understood by the ordinarily skilled person in the art. Filter pieces 30 may be made of any suitable filter material of a type commercially available. This material is selected to remove particulate matter from the inhaled air. Particularly suitable materials include commercially available filters made of electrostatically charged fibers, such as those manufactured by the 3M Corporation of St. Paul, Minn. If desired, an activated charcoal may be included to reduce unpleasant odors.

With reference now to FIGS. 7 and 8, a second exemplary embodiment of the filter device according to the present invention is illustrated. Here, filter device 110 has a general shape that is the same of that with respect to the first exemplary embodiment. Here, however, the support member 120 is formed to include a substrate 152 of a suitable plastic material and a metallic rib 154 which acts to reinforce substrate 152 and to provide malleability therefore. Thus, metallic rib 154 has an annular section 162 that extends around and is bonded to annular section 122 of substrate 152, side sections 164 that extend along side sections 124 of substrate 152 and a bridge section 168 that extends along and is bonded to bridge section 128 of substrate 152.

In this second embodiment, and in specific reference to FIG. 8, it may be seen the filter pieces 130 are convex in shape having an outer rim 132, a flat margin section 134 and a dome-shaped central section 136 so that it is of a more simple shape than the shape of filter piece 30, described above. However, it should be clearly understood that the shape of the filter pieces could be the same as in the first embodiment. Here, also, it may be seen that margin section 134 of filter piece 130 is located in a channel 140 formed in annular section 122 and that margin 134 of filter piece 130 is mechanically trapped in channel 140 by annular section 162 of metal rib 154.

Turning now to FIGS. 9 and 10, a third exemplary embodiment of the filter device according to the present invention is illustrated. Here, filter device 210 includes a support member 220 that includes a pair of annular sections 222 and a pair of side sections 224 that extend upwardly from outer locations 226 of annular sections 222. A filter piece 230 is disposed and is supported and each annular section 222 so that filter pieces 230 may be seated within the person's nostrils. Again, each of filter pieces 230 is dome-shaped in configuration, but they could be of other shapes as well.

In the embodiment shown in FIGS. 9 and 10, bridge section 28 is eliminated. Instead, annular sections 222 are interconnected by means of an inner band section 228 which extend between inner locations 232 of annular sections 222 that are generally opposite the outer locations 226 thereof. Band section 228 has an arch-shaped configuration with the arch projecting downwardly, so as to have a shape that is adapted to extend around and receive the columella 234 of the person's nose, as is shown in FIG. 9. Here, it should be appreciated that annular sections 222 are again spaced apart from one another a distance corresponding to the distance between the person's nostrils, and the malleability of support member 220, and especially side sections 224, allow the filter device 210 to be secured in a mounted position on the person's nose.

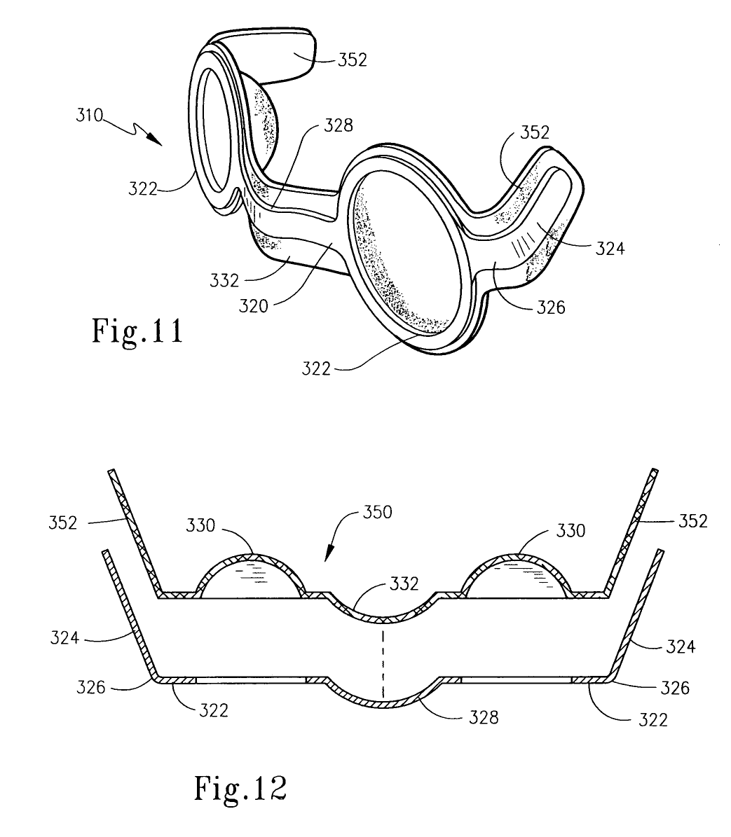

Finally, a fourth exemplary embodiment of the filter device according to the present invention is illustrated in FIGS. 11 and 12. Here, filter device 310 again includes a support member 320 having a pair of annular sections 322 having inner locations interconnected by means of a band section 328 and with a pair of side sections 324 extending upwardly from outer locations 326 opposite the inner locations. This support member 320 provides a support frame for a filter strip 350 that includes filter pieces 330 that are configured in a convex shape and which are interconnected by an inner strip 332 of filter material and an outer strip 352 of filter material that extends outwardly from each of filter pieces 330. Thus, filter strip 350 can be an integrally formed strip entirely made of filter material that is supported by a backbone in the form of support member 320 which may be the suitably malleable plastic, metal or other construction.

Accordingly, the present invention has been described with some degree of particularity directed to the exemplary embodiments of the present invention. It should be appreciated, though, that the modifications or changes may be made to the exemplary embodiments of the present invention without departing from the inventive concepts contained herein.

What is claimed is:

1. A filter device adapted to mount on a person's nose and fit within the person's nostrils when in a mounted state, comprising:
(A) a support member including a pair of annular sections and a pair of side sections extending upwardly from outer locations of said annular sections wherein at least some portion of said support member is malleable so that said support member may be configured to conform to the shape of the person's nose when in the mounted state to secure the support member thereto with said annular sections spaced apart from one another a distance corresponding to the distance between the person's nostrils; and
(B) a pair of filter pieces, there being one of said filter pieces disposed in each of said annular sections and being supported by said support member for seated engagement with respective ones of the person's nostrils.

2. A filter device according to claim 1 wherein said side sections are formed of a malleable material whereby said side portions can be configured to extend alongside the sides of the person's nose in generally confronting relation thereto when in the mounted state.

3. A filter device according to claim 2 wherein said side sections are interconnected by a bridge section configured to extend across the bridge of the person's nose, said bridge section being formed of a malleable material.

4. A filter device according to claim 1 wherein said side sections are interconnected by a bridge section configured to extend across the bridge of the person's nose.

5. A filter device according to claim 1 wherein said annular sections are interconnected by a band section extending between inner locations of said annular sections that are generally opposite the outer locations thereof.

6. A filter device according to claim 5 wherein said band section has an arch-shaped configuration adapted to receive the columella of the person's nose.

7. A filter device according to claim 1 wherein said support member includes a substrate formed of a plastic material and a metallic rib secured to said substrate.

8. A filter device according to claim 1 wherein said filter pieces are interconnected by an inner strip of filter material.

9. A filter device according to claim 8 including an outer strip of filter material extending outwardly from each of said filter pieces.

10. A filter device according to claim 1 wherein each of said filter pieces is formed as a shell having a generally convex shape.

11. A filter device according to claim 10 wherein each of said filter pieces has an outer rim, a generally flat margin section adjacent to said rim and a frusto-conical section extending upwardly from an inner edge portion of said margin, said margin section and said frusto-conical section forming a seat for the edges of the person's nostrils.

12. A filter device according to claim 11 wherein each of said filter pieces has a generally flat landing section extending from an upper edge portion of said frusto-conical section and a dome-shaped section extending upwardly from an inner edge portion of said landing section.

13. A filter device according to claim 1 wherein said filter pieces include electrostatically charged fibers.

14. A filter device adapted to mount on a person's nose and fit within the person's nostrils when in a mounted state, comprising:
(A) a support member including a pair of annular sections spaced apart from one another a distance corresponding to the distance between the person's nostrils and including a pair of side sections extending upwardly from outer locations of said annular sections, said side sections being formed of a malleable material whereby said side sections can be configured to extend alongside the sides of the person's nose in generally confronting relation thereto when in the mounted state; and
(B) a pair of filter pieces, there being one of said filter pieces disposed in each of said annular sections and being supported by said support piece for engagement with respective ones of the person's nostrils when in the mounted state.

15. A filter device according to claim 14 wherein said malleable material is selected from a group consisting of: plastics, metals and plastic coated metals.

16. A filter device according to claim 14 wherein said side sections are interconnected by a bridge section configured to extend across the bridge of the person's nose.

17. A filter device according to claim 14 wherein said annular sections are interconnected by a band section extending between inner locations of said annular sections that are generally opposite the outer locations thereof.
